(19) United States
(12) Patent Application Publication
(10) Pub. No.: US 2026/0148949 A1
(43) Pub. Date: May 28, 2026

(54) MASS SPECTROMETER PEAK IDENTIFICATION

(71) Applicant: Thermo Fisher Scientific (Bremen) GmbH, Bremen (DE)

(72) Inventors: Hamish Stewart, Bremen (DE); Johannes Petzoldt, Bremen (DE); Bernd Hagedorn, Bremen (DE); Yannick Mueller, Bremen (DE)

(21) Appl. No.: 19/391,282

(22) Filed: Nov. 17, 2025

(30) Foreign Application Priority Data
Nov. 27, 2024 (GB) 2417413.8

(51) Int. Cl. H01J 49/00

(52) U.S. Cl. CPC H01J 49/0036

(57) ABSTRACT

Method and system of analysing data generated by an ion analyser is disclosed. The method comprises receiving data generated by the ion analyser, identifying a region within the data generated by the ion analyser containing at least one feature, processing the identified region by: when one or more properties of the identified region meets one or more criteria using a first algorithm to identify one or more individual peaks within the identified region and a second algorithm to determine properties of the one or more individual peaks within the identified region, when the identified region does not meet the one or more criteria using a third algorithm to determine properties of one or more individual peaks within the identified region.

### CROSS-REFERENCE TO RELATED APPLICATIONS

This application claims the benefit under 35 U.S.C. § 119(b) of United Kingdom Application no. GB2417413.8 filed Nov. 27, 2024. The entire content of the aforementioned application is incorporated by reference herein.

### FIELD

The present invention relates to a system and method for identifying peaks within mass analyser and spectrometry data, and in particular for resolving individual components more accurately.

### BACKGROUND

Mass spectrometers generate graphical data including features and peaks corresponding to individual components in a sample. Computational techniques can be used to resolve peaks within the data and measure properties of the ion peaks that may be present. When ion masses or mass-to-charge ratio (m/z) values for different components are similar, their peaks will be close and can overlap. This can be particularly prevalent in relatively low-resolution mass spectrometers and time-of-flight (ToF) mass spectrometers, in particular.

Whilst different species can form overlapping peaks in the data, other physical effects can cause individual features in a mass spectrum to split into more than one peak, which could be confused with different components in the sample.

FIG. 1A illustrates a portion of a mass spectrum of a sample containing two different components of different m/z, which produces different ion flight times (in a ToF mass spectrometer). In this example data, the two corresponding peaks in the spectrum overlap. The overlapping peaks need to be disentangled to estimate the arrival time and/or other parameters for each of the two individual ion species.

FIG. 1B illustrates a portion of a mass spectrum of a different sample containing a single ion species. These data include a multi-modal peak, where this peak should not be interpreted as a signal resulting from different ion species (as in the case shown in FIG. 1A) but should instead be treated as a signal originating from a single ion species only. As shown in FIG. 1B, if only a few ions of a species are detected, it is very probable that a multi-modal signal will be formed. If many such signals were to be averaged, then a unimodal peak may emerge having a similar shape to the arrival time distribution. However, averaging can be time consuming and inefficient. Similarly, a larger number of ions and a better signal-to-noise ratio could reduce the chance of encountering misleading multimodal peaks, but this cannot always be achieved.

GB2617318A describes a process for resolving individual components in ToF mass spectrometer data. However, this process can still result in features from single m/z ion types being split into several distinct peaks.

Therefore, there is required a method and system that overcomes these problems.

### SUMMARY

A mass analyser or mass spectrometer, such as a time-of-flight (ToF) mass spectrometer (i.e., including one or more mass analysers), produces data including features relating to one or more ion species being analysed. Ion masses or mass-to-charge ratio (m/z) values for different components should generate different features or peaks within the data (when graphically displayed). However, features generated by individual ion mass species can produce split peaks. Different techniques and algorithms can be used to process the features or segments of the data. Whilst these techniques may be very effective in resolving multiple peaks within a feature, this can result in split peaks being erroneously identified as different m/z values when they come from the same ion mass species. To avoid this, properties of each feature within the mass spectrum data are determined. For example, the property of amplitude or peak height (e.g., the maximum count value within a feature) can be determined. Other properties may be included.

The determined property or properties of the feature is or are compared to one or more criteria. The criteria may be one or more thresholds, for example.

If the one or more criteria are met with a particular feature, then one type of processing (a first type) may take place. If the one or more criteria are not met, then another type or processing (a second type) may be carried out. For example, if the feature maximum count value is below a threshold (e.g., a predetermined or dynamically calculated threshold) then the first processing type may be carried out and if the maximum count value is above the threshold, then the second processing type is carried out.

The first type of processing may include a step not carried out in the second type of processing but with other steps that are common to both. Alternatively, the two types of processing may be wholly different with little or no common functions.

Optionally, the first type of processing includes a step or algorithm to deconvolve the two or more peaks within the feature under consideration (i.e., to identify if more than one real peak is present and/or resolve that single peak into two or more peaks relating to different m/z values). Therefore, the criteria being met could indicate that a region containing a feature under consideration may be formed by two or more ion species and that applying a deconvolution algorithm is unlikely to cause the splitting of a single peak (due to a single ion species). For example, when the signal, amplitude or the maximum number of counts in the feature is low (below a threshold) then this can indicate that there is insufficient concentration of ions to cause space charge effects that could lead to the feature splitting. Therefore, for these lower amplitude peaks (below the threshold) the deconvolution or resolving algorithm may be carried out (e.g., to determine if it actually contains two or more different ion species or m/z values).

If the signal, amplitude or the maximum number of counts in the feature is high (above the threshold) then this can indicate that there is sufficient concentration of ions to cause space charge effects to cause feature splitting. Therefore, for these higher amplitude peaks (above the threshold) the deconvolution or resolving algorithm is not carried out to avoid results indicating different ion species when only one is present in the identified feature.

In both cases, properties of the any individual peaks within the identified region can be determined (e.g., using curve fitting techniques). These can generate data about the peaks (e.g., amplitude, height, maximum value, width, full width half maximum - FWHM, etc.). These data can be determined using the same or different techniques whether or not the original one or more criteria are met.

The method may be implemented as part of the process of obtaining mass spectrometer data. For example, the method may be implemented within a control system for a mass analyser or mass spectrometer. Therefore, this provides a mass analyser or mass spectrometer with improved operation providing more accurate results. Alternatively, the method may be implemented within a computer system external to the mass analyser (including from data stored sometime after operation of the mass analyser). Such a computer system may generate data describing real world results for samples that could otherwise be difficult or impossible to derive.

Processing the region within the data generated by an ion analyser uses the first algorithm to identify one or more individual peaks if the region meets the one or more criteria (e.g., carried out for lower intensity signals). Regions of data with a maximum intensity value at or above a particular threshold (e.g., a first threshold) are not subjected to the first algorithm (e.g., a deconvolution algorithm) because they may suffer from artificial peak splitting (e.g., because space-charge effects may be apparent in higher signal samples). Properties of one or more individual peaks within such a higher signal region are obtained immediately using a third algorithm, e.g., without using a deconvolution algorithm to identify peaks.

The third algorithm may be the same as the second algorithm, but the third algorithm does not include the first algorithm. The third algorithm may not include steps to identify and/or separate peaks and only determines properties of peaks within the region of data.

In accordance with a first aspect there is provided a method of analysing data generated by an ion analyser, the method comprising receiving data generated by the ion analyser, identifying a region within the data generated by the ion analyser containing at least one feature, and processing the identified region by: when one or more properties of the identified region meets one or more criteria using a first algorithm to identify one or more individual peaks within the identified region and a second algorithm to determine properties of the one or more individual peaks within the identified region, and/or when the identified region does not meet the one or more criteria using a third algorithm to determine properties of one or more individual peaks within the identified region, wherein the one or more criteria comprises the maximum intensity value or area of the data within the identified region being below a first threshold. Therefore, the most appropriate data processing technique can be used for each feature or region of data. This can avoid not resolving two or more distinct peaks (from different ion species) when they should be resolved and also avoids two or more separate peaks being resolved, deconvolved or generated as an artefact splitting a single peak (due to one ion species) into separate peaks.

For some data sets there may be peaks located nearby but in adjacent regions. Therefore, there may be some overlap or leaking of a contribution of a portion of one peak to another. The second algorithm may include processing or steps to identify such a situation and to exclude such a contribution of neighbouring peaks to the one or more individual peaks fully within the region, or otherwise compensate for such a situation.

Optionally, the second and third algorithms may be the same. In this case, when one or more criteria are met, a more complex process with additional steps may take place to process the feature and when the one or more criteria are not met then a simplified process is applied to the feature.

Optionally, the second and/or third algorithms may be centroiding algorithms to calculate a centre value of the one or more individual peaks. For example, the centroiding algorithm (i.e., a process to determine the centre, time or m/z value for a peak) may divide the peak in half, such that the area on the left-hand and on the right-hand side are the same and report the time (corresponding to m/z value in a ToF spectrometer) at which this cut is placed. Other algorithms may be used.

Optionally, the centroiding algorithm may provide an output comprising m/z, arrival time, or time of flight positions and intensities of the one or more individual peaks.

Optionally, the centroiding algorithm may provide an output further comprising a resolution of the one or more individual peaks. Other data may be provided

Optionally, the first threshold corresponds to an intensity level at which space charge induced bifurcation occurs. This intensity level of the first threshold can correspond with a concentration of ions (or the particular ion under investigation) causing significant space charge effects to occur and cause splitting in the peak. Such an intensity level may be determined by performing a series of tests using increasing ion concentrations for different samples until bifurcation occurs, for example.

Optionally, the one or more criteria may comprise the maximum intensity value of the data within the region being above a second threshold. This second threshold may be a value corresponding to a noise level that results in multiple erroneous peaks. In other words, applying this threshold can filter out peaks likely to be due to noise in the data, which speeds up processing and reduces erroneous data.

Optionally, the intensity value may be any one of: number of counts, number of ions, or number of arbitrary units. Other units may be used.

Optionally, the threshold (e.g., first and/or second threshold) may be set based on a m/z value or arrival time (e.g., for a ToF mass analyser) of a peak within the identified region. The thresholds may be set by other techniques or fixed in advance across a range or m/z values or first arrivals times for ions in a ToF mass analyser.

Optionally, the threshold (e.g., first and/or second threshold) may be based on a calibration curve including the m/z value or arrival time (e.g., for a ToF mass analyser). The calibration curve may be specific to a mass analyser and/or a sample type. The calibration curve or thresholds may be derived in advance from conducting experiments to determine intensity levels that cause splitting of individual peaks or calculated based on the probability of space charge effects being significant and likely to cause artifacts in the data.

Optionally, the first algorithm may be a deconvolution algorithm. The first algorithm may be configured to identify a plurality of individual peaks within the identified region (and so will identify a plurality of individual peaks when a plurality of individual peaks are present within the identified region, but will identify a single peak when only a single peak is present within the identified region).

Optionally, the deconvolution algorithm may comprise receiving a first segment of data generated by the ion analyser, wherein the first segment of data comprises data associated with a first arrival time range, applying a filter to the first segment of data so as to produce a filtered version of the first segment of data, optionally wherein a width associated with the filter is configured to depend upon a width of an expected ion arrival time distribution for the ion analyser for arrival times within the first arrival time range, and then identifying one or more ion peaks in the filtered version of the first segment of data. This deconvolution algorithm is described in more detail in GB2617318 and these details and steps may be used within the present example implementation. Other deconvolution algorithms may be used.

Optionally, the third algorithm may comprise the steps of identifying a local minimum between two higher intensity local maximum regions within the identified region, when a difference or a percentage difference between the local minimum and at least one of the two local maximum regions is above a threshold identify the two local maximum regions as separate ion peaks, and determining the centre positions and/or widths of the two local maximum regions. This third algorithm may be used when there is a high likelihood that two more real peaks (due to different ion species) are present in the feature or at least when it is unlikely a splitting of peaks has occurred (e.g., because the intensity is below a threshold likely to cause splitting-inducing space charge effects).

Optionally, the third algorithm may comprise the steps of identify a local minimum between two higher intensity local maximum regions within the identified region, when an intensity of the local minimum is below a threshold identify the two local maximum regions as separate ion peaks, and determining the centre positions and/or widths of the two local maximum regions.

Optionally, the steps of processing the identified region may be repeated on a plurality of identified regions until all regions within the data generated by the ion analyser are processed. Therefore, the method may be used to process a full data set or mass spectrum. However, the method may be used only with one or a subset of features in the data set.

Optionally, the ion analyser may be a time of flight (ToF) mass analyser (or mass spectrometer). Other ion analysers may be used. Different ion analysers may use different criteria and/or algorithms to process the data.

Optionally, the step of identifying the region further comprises limiting the width of the identified region to a first m/z or arrive time range. The method and first algorithm may be used in the context of ion mobility spectrometry.

Optionally, the step of identifying the region within the data generated by the ion analyser containing at least one feature may further comprise the step of selecting the region within the data fully enclosing the feature without including a neighbouring feature. This can be used to effectively separate peaks.

In accordance with a second aspect, there is provided apparatus comprising:
a processor and memory storing computer-executable instructions that, when executed by the processor, cause the apparatus to execute the method, as described above.

Optionally, the apparatus may be a mass spectrometer.

According to a third aspect, there is provided a control system for an analytical instrument or mass spectrometer, the control system configured to cause the analytical instrument to perform the method as described above.

The methods described above may be implemented as a computer program comprising program instructions to operate a computer. The computer program may be stored on a computer-readable medium, including a non-transitory computer-readable medium.

The computer system may include a processor or processors (e.g., local, virtual or cloud-based) such as a Central Processing Unit (CPU), and/or a single or a collection of Graphics Processing Units (GPUs). The processor may execute logic in the form of a software program. The computer system may include a memory including volatile and non-volatile storage medium. A computer-readable medium (CRM) may be included to store the logic or program instructions. For example, embodiments may include a non-transitory computer-readable medium (CRM) storing software comprising instructions executable by one or more computers which, upon such execution, cause the one or more computers to perform the disclosed methods. Non-transitory CRM may refer to a CRM that stores data for short periods or in the presence of power such as a memory device or Random Access Memory (RAM). For example, a non-transitory computer-readable medium may include storage components, such as, a hard disk (e.g., a magnetic disk, an optical disk, a magneto-optic disk, and/or a solid state disk), a compact disc (CD), a digital versatile disc (DVD), a floppy disk, a cartridge, and/or a magnetic tape. The different parts of the system may be connected using a network (e.g. wireless networks and wired networks). The computer system may include one or more interfaces. The computer system may contain a suitable operating system such as UNIX™, Windows™ or Linux™, for example.

It should be noted that any feature described above may be used with any particular aspect or embodiment.

### BRIEF DESCRIPTION OF THE FIGURES

The present disclosure may be put into practice in a number of ways and embodiments will now be described by way of example only and with reference to the accompanying drawings, in which:

FIG. 1 shows graphical data indicating problems with known data processing techniques;

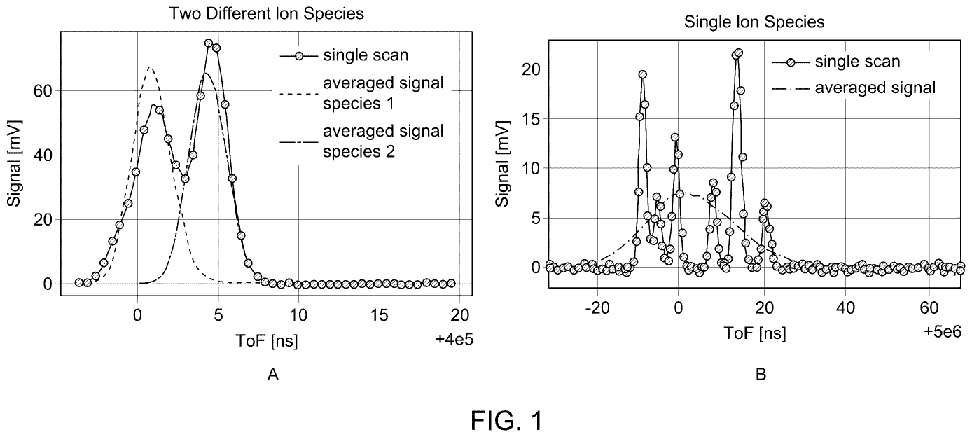

FIG. 2 shows graphical data indicating benefits of data processing techniques; and

FIG. 3 shows graphical data indicating space charge effects in mass spectrometry data;

FIG. 4 shows a flowchart of a method for analysing data from a mass analyser;

FIG. 5 shows a system for implementing the method of FIG. 4;

FIG. 6 shows a flowchart of an example method for analysing data from a mass analyser;

FIG. 7 shows graphical data indicating how calibration data may be generated for use in the method of FIG. 4 or 6;

FIG. 8 shows further graphical data indicating space charge effects in mass spectrometry data;

FIG. 9 shows graphical data indicating how different parameters may be used to generate calibration data for use in the method of FIG. 4 or 6; and

FIG. 10 shows simulated graphical data illustrating peaks splitting due to space charge effects.

It should be noted that the figures are illustrated for simplicity and are not necessarily drawn to scale. Like features are provided with the same reference numerals.

### DETAILED DESCRIPTION

For relatively low-resolution mass spectrometers, overlapping peaks may be prevalent, and peak deconvolution or peak splitting algorithms are required. For high resolution analysers, such as the Thermo Fisher Scientific™ Orbitrap™ Astral™ mass spectrometer, it may not be necessary to utilise such a process, at least for the MS/MS analysis that the Astral™ analyser excels in, due to the lack of overlapping features in a regular spectrum. Nevertheless, samples can still generate peak doublets. For example, tandem mass tag (TMT) reporter ions, can produce isobaric doublets that may slightly overlap even at relatively high (70 k+) resolving power. It has been noticed that this is particularly the case for intense peaks, which can cause resolving power to fall due to space charge effects.

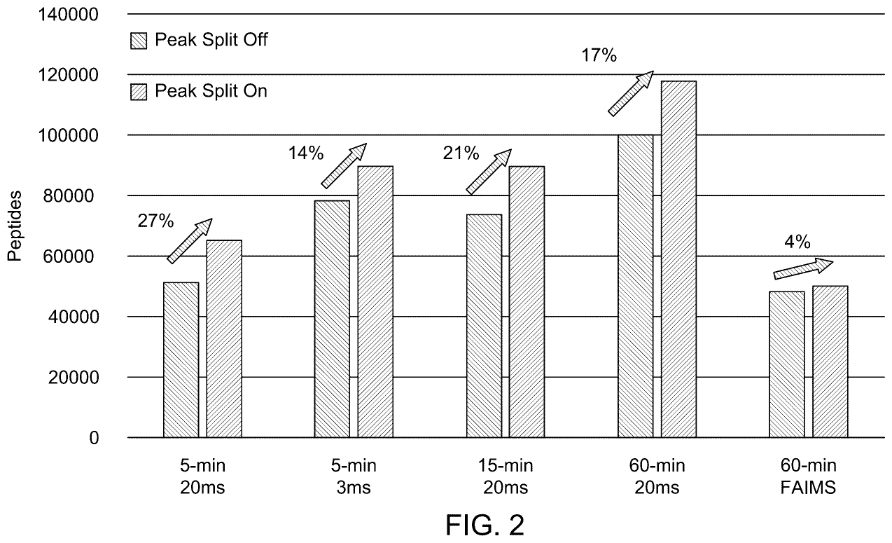

Experiments with liquid chromatography mass spectrometry (LC-MS) have indicated that there are significant gains to be made with the implementation of peak splitting algorithms across the entire mass range, even for ion analysers having resolving power of around 100 k and above. FIG. 2 shows a graph of example experimental data including of a number of peptides identified by the Orbitrap™ Astral MS from an LC-MS analysis of 100 ng HeLa digest for a range of LC gradient lengths and maximum ion accumulation times. The application of a peak splitting algorithm makes a substantial difference to the depth of analysis, particularly for the short 5-minute experiments with a long 20 ms ion accumulation time, which generate more populated and thus congested spectra. Where the analyser is less populated, either by short 3 ms ion accumulation time, long 60-minute LC gradient, or the use of field asymmetric waveform ion mobility spectrometry (FAIMS) to enhance selectivity, the improvement may be more modest but still valuable.

However, a problem arises with the application of peak deconvolution algorithms to data generated by this type of analyser, and other relatively slow high sensitivity ToF analysers. Most ToF analysers launch quite low population ion packets but do so rapidly, at 5-10 kHz, and build up spectra by averaging many such events. Some analysers instead accumulate large numbers of ions in an ion trap mounted at the entrance to the flight region, prior to a much less frequent (˜200 Hz) pulsed extraction. This extraction ion trap is far more efficient than traditional orthogonal extractors at getting ions into the ion analyser, but the sensitivity advantage is tempered by the high per-pulse ion load which can see thousands of ions of a single m/z in a single pulse.

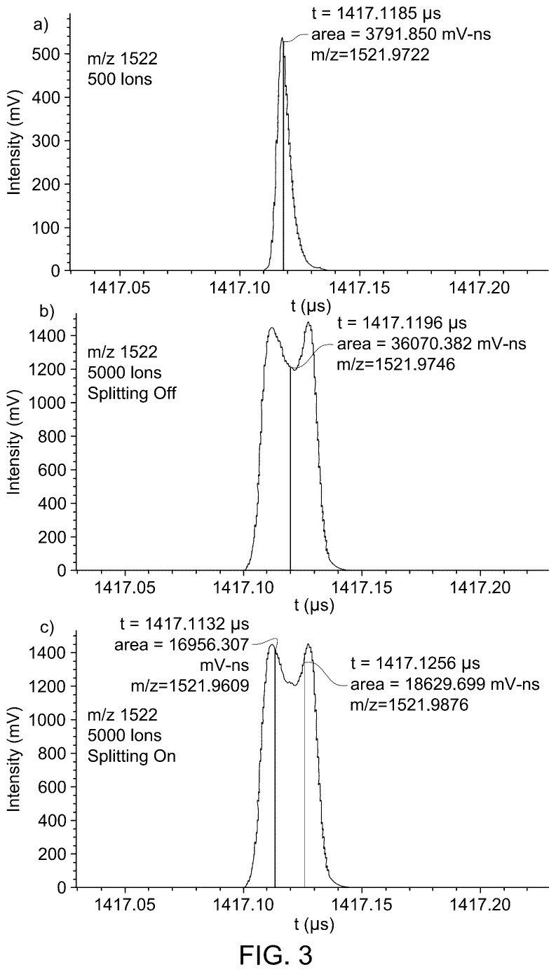

Such intense pulses impose (largely resolved) challenges on the dynamic range of detection but can create strong space charge effects that work against the analyser's focusing fields and reduce resolution, typically to ˜50 k when >1000 ions of a single m/z fly together. While this can usually be tolerated, a dangerous effect has been observed on the peak shape whereby instead of simply broadening to occur, very intense peaks may start to bifurcate, or even trifurcate. This is shown in the graphs of FIGS. 3a, 3b and 3c, which illustrate the consequence of a peak splitting or deconvolution algorithm erroneously fitting two peaks to a single feature, even though it contains only one m/z species. This can have a severe impact upon mass accuracy and quantitation.

FIGS. 3a, 3b and 3c illustrate a m/z of 1522 ion profile peak with a calculated centroid at a) 500 ions in peak, b) 5000 ions in peak with overlapping peak deconvolution disabled, and c) 5000 ions in peak (showing the effect of a deconvolution algorithm on the feature).

It has been determined that counterintuitively, that more primitive centroiding of feature which are convoluted in this way provides more effective and accurate results, preserving mass accuracy and quantitation. Therefore, it is beneficial to use properties of features to determine different techniques or algorithms that should be used to process those features to obtain more optimal results and accurate analysis. Therefore, a selection of processing technique may be based on properties of the features detected in the mass data. This can be carried out automatically with the most appropriate technique or algorithm applied to each feature. There may be two or more different techniques or algorithms to be selected but the following describes two such examples.

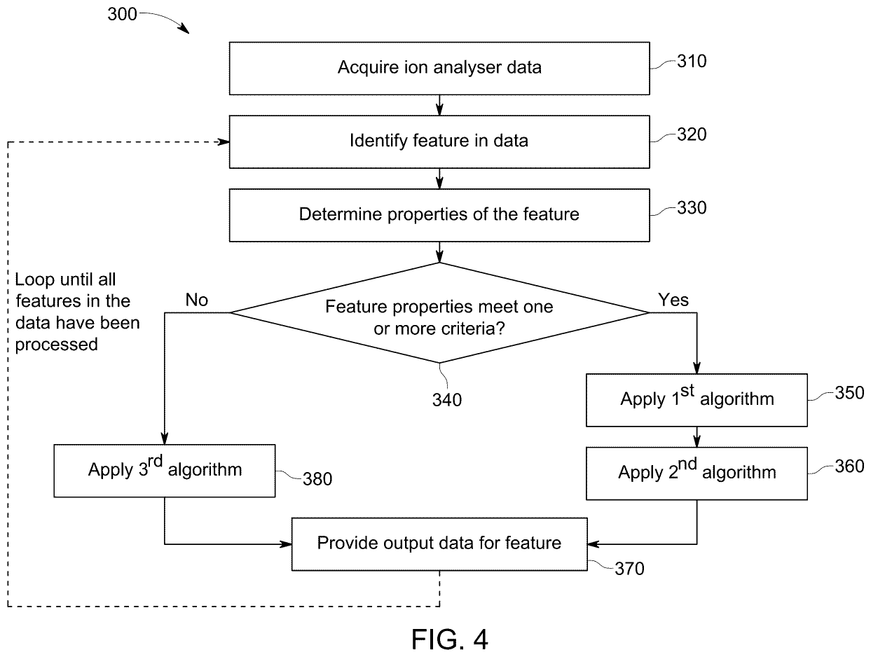

FIG. 4 shows a flowchart of a method 300 used to process data from an ion analyser, such as a time-of-flight (ToF) mass analyser or spectrometer. At step 310 data from the ion analyser is acquired. This may be directly from the ion analyser (e.g., a ToF mass spectrometer) or retrieved from a data store or database of previously recorded, stored and retrieved data.

At step 320 a feature within the data is identified. This may be done by identifying peaks having an intensity greater than a noise threshold or by another suitable method. In particular embodiments, the signal and/or the collection of digital samples is divided into a plurality of segments in a data-dependent manner. Segment(s) may be generated when the ion intensity exceeds a threshold. For example, a segment or feature may begin when the intensity of a sample exceeds a first feature threshold and may end when the intensity of a sample drops below a second feature threshold. The first and second feature thresholds may be the same or may be different. Where the intensity drops below the second feature threshold only briefly (e.g., below a predetermined value), the segment or feature may be continued. This may be achieved, for example, by configuring the digitiser such that a segment or feature is ended only if the signal remains below the second feature threshold for a certain number of samples. It would also be possible for a segment or feature to begin a certain number of samples before the intensity of a sample exceeds the first feature threshold and/or to end a certain number of samples after the signal falls below the second feature threshold (e.g., set by a dynamic or static parameter).

However, the feature is identified, its properties are determined at step 330. For example, a maximum intensity (e.g., amplitude, data counts, ion number, etc.) or area within the data forming the feature may be determined. Other features may be determined, including but not limited to peak width, peak shape, full width half maximum (FWHM), etc.

At step 340, the feature property or properties are compared with one or more criteria. In a simple example, the maximum intensity identified within step 330 may be compared against one or more thresholds. The one or more criteria may be met when the maximum intensity is below a threshold, above, a threshold and/or between two different thresholds.

Features having properties that meet the one or more criteria are processed according to the “Yes” stream of steps (350, 360, 370). Step 350 applies a first algorithm to the data of the feature. The first algorithm can deconvolve, extract or identify individual peaks within the single feature. The output of the first algorithm (e.g., time or m/z values of individual peaks and data of the feature are processed according to the second algorithm (step 360). The second algorithm may generate parameters describing the individual peaks and step 370 provides an output (e.g., from the second algorithm) indicating properties of each peak.

Features that do not meet the one or more criteria are processed according to the “No” stream of steps (380, 370). In this case only a single algorithm is applied, and no complex deconvolution algorithm (first algorithm) is applied. Therefore, the third algorithm only generates an output (e.g., parameters) describing the individual peak or peaks in the data. This output is provided at step 370. The method 300 may iterate from step 320 to step 370 until all identified features have been sorted and processed. The method 300 may be implemented by a separate computer system or by a computer system or control system used to operate a mass analyser or mass spectrometer.

It should be noted that even if the one or more criteria are not met for a particular feature, it may still contain more than one real peak (i.e., relating to different ion species). However, this feature (with more than one peak) does not meet the criteria for deconvolution. The third algorithm may still identify individual peaks (if they are separated by a sufficient amount) using a crude peak separation technique (at least compared with the first algorithm).

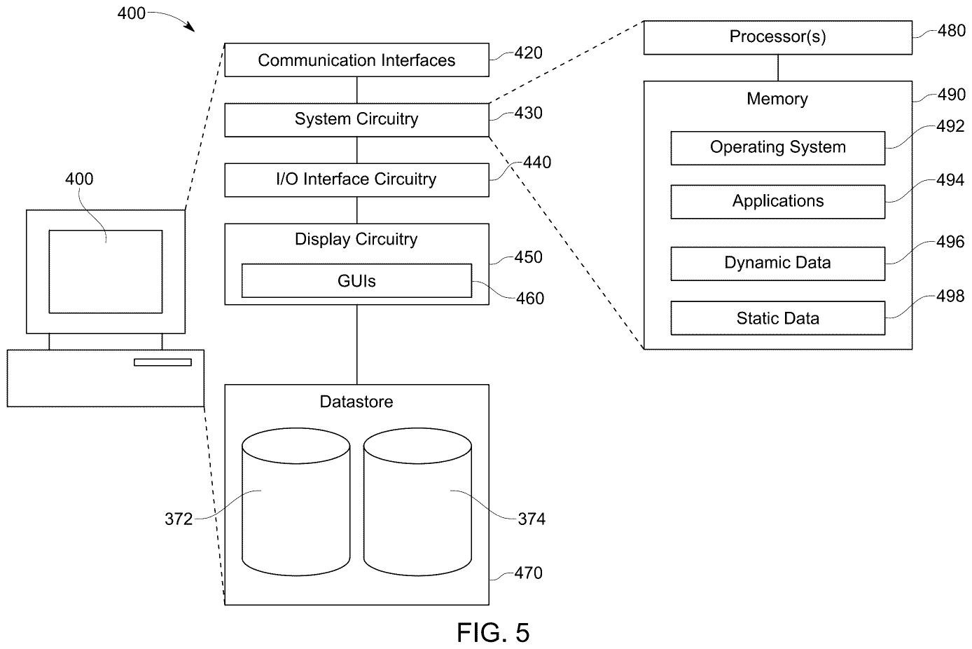

As shown in FIG. 5, the computer system 400 (e.g., a controller of a mass spectrometer) includes a number of components including communication interfaces 420, system circuitry 430, input/output (I/O) circuitry 140, display circuitry and interfaces 450, and a datastore 470. The system circuitry 420 can include one or more processors or CPUs 480 and memory 490. The system circuitry 430 may include any combination of hardware, software, firmware, and/or other circuitry. The system circuitry 430 may be implemented, with one or more systems on a chip (SoC), application specific integrated circuits (ASIC), microprocessors, and/or analogue and digital circuits.

The display circuitry may provide one or more graphical user interfaces (GUIs) 460 and the I/O interface circuitry 440 may include touch sensitive or non-touch displays, sound, voice or other recognition inputs, buttons, switches, speakers, sounders, and other user interface elements. The I/O interface circuitry 440 may include microphones, cameras, headset and microphone input/output connectors, Universal Serial Bus (USB) connectors, and SD or other memory card sockets. The I/O interface circuitry 440 may further include data media interfaces (e.g., a CD-ROM or DVD drive) and other bus and display interfaces.

The memory 490 may include volatile (RAM) or non-volatile memory (e.g., ROM or Flash memory). The memory may store the operating system 492 of the computer system 400, applications or software 494, dynamic data 496, and/or static data 498. The datastore or data source 470 may include one or more databases 472, 474 and/or a file store or file system, for example.

The second and/or third algorithms (steps 360 and steps 380 of FIG. 4) may be the same or different algorithms. In an example implementation they may both be some form of centroiding algorithm that provides data indicating a time or m/z value for peak or peaks within a feature of the mass analyser data. This may be based on finding a maximum value of a peak and the corresponding m/z value at this maximum. This may also use a centre of mass calculation, which can find an intensity weighted average. Further algorithms may include smoothing techniques (e.g., the Savitsky-Golay method) or fitting a peak to a function prior to calculation of the centre vale for the peak (e.g., extracted from the parameters of the fitted curve).

A further example for calculating parameter(s) of the peaks may be by fitting a suitable (single) peak model to the data within the feature. Any suitable peak model may be used, such as for example a Gaussian or an asymmetric Gaussian.

In a further example, the second and/or third algorithms (e.g., centroiding algorithm) may cut a peak in half (perpendicular to the time or m/z axis), such that the area on the left-hand and on the right-hand side are the same. The algorithm can then report the time (m/z value) at which this cut is placed. Additionally, this may only take samples between the left-half maximum and the right half-maximum. This provides a more robust exclusion of noise and other unwanted anomalies in the tails of long tailed peaks.

Features may be identified with the ion analyser data using any appropriate technique (step 320). For example, after applying a threshold to exclude noise, a series of isolated spectral features may result that form a spectrum. These features can be processed sequentially within the loop shown in the method 300 of FIG. 4.

A time-of-flight spectrum may be recorded using a digitiser (with the noise excluded or removed using a noise threshold). These thresholds may be predetermined, but the detector may be calibrated such that a fixed number of ions (at a fixed m/z) produces a fixed signal. This ensures that it is known how many ions are contained within each peak, or at least a signal area for the peaks is ensured to be consistent. This may be pre-programed or calibrated to set a limit for ion number (or peak intensity). The threshold may be calculated or adjusted for each specific m/z value using one or more calibration curves. For example, if parameters are used to generate an intensity threshold for a peak (e.g., including parameters for both m/z and trap RF amplitude), then a calculation or threshold value may be made after the feature is detected. Different calibration curves may be defined for different sample types, concentrations, mass analysers and/or mass analyser settings or parameters, for example.

Existing deconvolution algorithms may incorporate low-intensity signal thresholds, below which deconvolution is not applied, preventing the processing system from being overwhelmed by dealing with tiny signals or residual noise. However, it has been found that for particularly high intensity signal peaks it is advantageous to prevent deconvolution algorithms being applied that would otherwise incorrectly generate bifurcated peaks (or more splitting). This requires applying a high-intensity threshold (as well as or instead of the low-intensity threshold to prevent noise, and optionally both), above which the deconvolution algorithm is not applied. This ensures that only features that fall short of the intensity required to cause unwanted bifurcation (e.g., due to space charge or other effects) would be eligible for the deconvolution algorithm. This level may be predetermined or set dynamically based on properties of the apparatus and/or sample.

There are different types of deconvolution algorithms (or first algorithms) that may be used. In an example implementation, a mass dependent smoothing is applied and then a spectral feature may be cut at local minima of the smoothed signal. The centroid and area under the spectral feature may be calculated within these segments independently. Additional processing may be applied to take into account signal leaking signal from one segment to another. Simplified algorithms may speed up processing, especially when there is limited available processing time (e.g., to process thousands of peaks at 200 Hz).

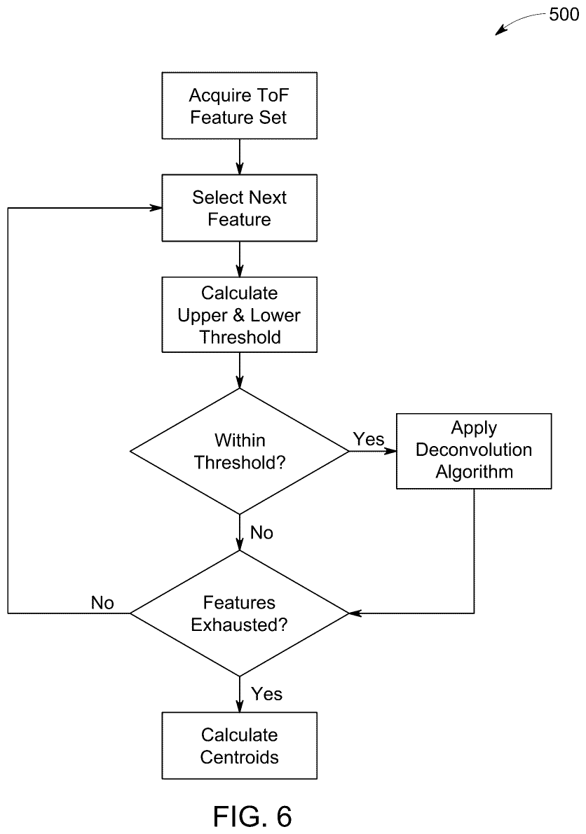

FIG. 6 shows a flowchart of an example implementation of the method 500. In this example implementation, the criteria for selecting the first set or second set of algorithms to process each feature in a data set are based on thresholds (selected, calculated, dynamic, or predetermined). Individual features within an acquired spectrum (e.g., from a ToF mass analyser) are selected. Upper and lower (if used) thresholds may be calculated (in this example). A determination is made if the feature property to be compared with the threshold(s), e.g., intensity, number ions, width, etc. is or are above and/or below the respective threshold(s) (e.g., within a band). If the criteria are met, then a peak deconvolution algorithm is applied. If the criteria are not met (e.g., if the intensity is above the upper threshold), then the deconvolution algorithm is not carried out.

The signal processing can move through each feature or segment of the data until the determination is made for each, i.e., which features are deconvoluted and which are not. In this example, when all features have been compared with the threshold(s) in this way then a centroiding algorithm is executed on each feature to generate accurate m/z positions, intensities or other attributes (i.e., the third algorithm in method 300 described with reference to FIG. 4).

In an example implementation, the method 300, 500 may be implemented on data generated by the Orbitrap™ Astral™ MS. This instrument has been described in US10699888B2. In this example implementation, the instrument combines Orbitrap and Astral™ mass analysers with quadrupole isolation and an electrospray ion source. In a typical MS/MS analysis, narrow ranges of analyte ion are quadrupole isolated from the electrosprayed sample, fragmented in an ion processor, and then mass analysed by the Astral™ analyser. While the time given for ions to accumulate in the ion processor may be varied to control overall ion population, the distribution of ions of different m/z cannot be so easily adjusted, and individual intense peaks can arise. The dynamic range of the Astral™ analyser may be able to keep up with thousands of ions in a single peak, against a background of tens of thousands of ions accumulated in the trap.

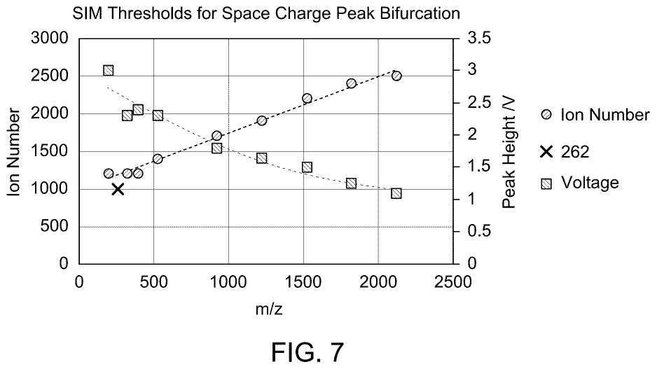

When determining a value to set for the high threshold for peak splitting (i.e., the threshold over which no deconvolution or first algorithm is applied), it is preferable to refer to measurements showing where peak shape distortion starts to occur (e.g., visibly). FIG. 7 shows a graph of such measurements for a wide m/z range of isolated ions (in this example, Pierce™ FlexMix™ calibration solution was used), in terms of peak height in volts, and ion number, which is calculated from a peak area, with a correction for m/z. It is noted that distortion in peak shape may be visible before bifurcation becomes severe enough for the peak splitting algorithm (deconvolution algorithm) to generate two separate peaks from a single ion. As shown in FIG. 7, peak height drops considerably with m/z. This is because peak height falls for a given number of charges with m/z in ToF analysers. Whilst peak height may not be an ideal metric for determining bifurcation, it is very easy to measure and calculate quickly, which has advantages when processing hundreds of thousands of features per second.

As described previously, space charge effects are generally dependent on the number of ions. The number of ions can be determined and used to calculate the high or upper threshold used as at least one criteria for carrying out the first algorithm. This high or upper threshold may be calculated during the sample investigation or at another time. The ion number trend in the example data appears almost flat for the lowest m/z ions (where bifurcation is not apparent), and then increases almost linearly (where bifurcation occurs). A cause of the step at low m/z values may be that the trap RF amplitude is able to scale with m/z, maintaining trapping performance, until about m/z 250, after which the pseudopotential well depth fell with increasing m/z, and the charge density within the trap decreased, increasing the apparent tolerance to space charge of the ions in flight. In the results shown in FIG. 7, the doubly charged MRFA ion at m/z 262 (indicated with a cross in FIG. 7) also shows a marked decrease in tolerance to space charge, which results from the deeper pseudopotential well for m/z 262 relative to its thermal energy spread.

In an example implementation, a fixed high threshold can be based on ion number selected so that under this high threshold every likely ion m/z and charge state will not bifurcate. In the example shown in FIG. 7, this high threshold may be at or around 1000 ions (but other number may be used, including 500, 1500, 2000, 3000, etc.). Mode dependencies or knowledge of a precursor charge state could modify the threshold, as these allow prediction of likely fragment charge states. The threshold could clearly also be made m/z dependent. The threshold may also be based on a trapping parameter q or a pseudopotential well depth to better link the threshold to the source of the dependency (e.g., initial ion trapping conditions).

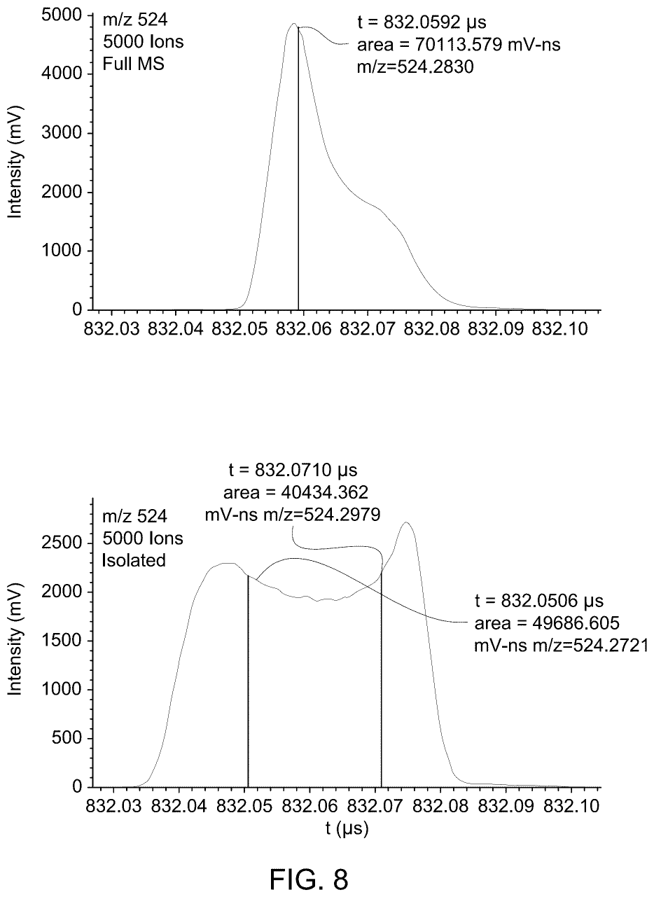

Another factor that may be taken into account in setting the one or more criteria is that measurements of isolated ions may be unrepresentative of the conditions of the majority of ions analysed. Normally the trap contains a mixture of different m/z ions, which under space charge push higher m/z ions out to the fringes of the trap. This in-trap space charge effect reduces charge density for most species, paradoxically increasing tolerance to resonant space charge effects that occur in the ToF analyser. FIG. 8 shows graphical data including a heavily bifurcated feature (lower graph) produced by 5000 isolated m/z 524 ions collapses back into a single peak (upper graph) when the ions are co-trapped with 100,000 ions covering the m/z 150-2000 mass range (e.g., from the FlexMix™), including lower mass species at m/z 195 and 262.

It is possible to take the global space charge effect into account when calculating the high or upper threshold. The lowest m/z species in the distribution behave more like isolated ions, while higher m/z species become more tolerant to space charge. However, calculating thresholds under such conditions may require producing a distribution map, e.g., by binning features within m/z bands to simplify the calculation.

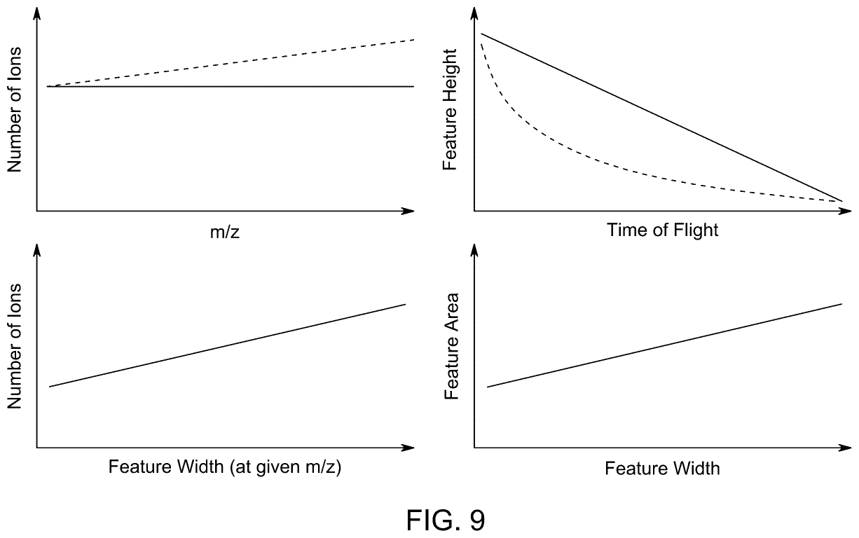

FIG. 9 shows graphical results illustrating parameters that may be used to calculate the high or upper threshold. Height, area, and number of ions are all linked properties, and may be scaled by m/z, ToF, and feature width, which are themselves all linked together. Feature width (whether baseline, 10%, or full width half maximum, etc.) may be useful as an additional parameter on top of existing scaling, as a means to determine if a feature is too wide to be bifurcated, and thus a means to differentiate bifurcation from multiple analyte species within large features.

Certain areas of a spectrum may contain known features with a well understood behaviour. For example, TMT reporter ions in region of the spectrum, around m/z 120, are well defined and known and positions of complementary TMTc ions may be inferred from the mass and charge state of an isolated precursor. Isobaric reporter ions appear in doublets (or quadruplets) and consequently the upper threshold for splitting these features may be relaxed, raised, or removed.

Whilst the technique and method 300, 500 reduce the risk of data from a single ion species being split or bifurcated, there may be situations and samples that have closely neighbouring (real) peaks and these data having overlapping isobaric features of multiply charged ions (where peak splitting is desired) need to be distinguished from a single m/z overloaded peak, where peak splitting should be avoided. As is apparent, an intensity threshold may not help to differentiate these results. While the threshold could simply be removed when analysing multiply charged precursors (if their time of flight or m/z is known), top-down MS/MS experiments can produce mixtures of charge states, and it is valuable to observe intense singly charged fragments. Feature width (or similarly the ratio of height to area) could be used to determine how to apply an upper intensity filter, as intense multiply charged ion features are broader on average than intense singly charged ion features.

While the high or upper threshold concept is described for the certain types of analyser (e.g., the Astral™ analyser), it may be applied to any time-of-flight analyser where space charge effects occur.

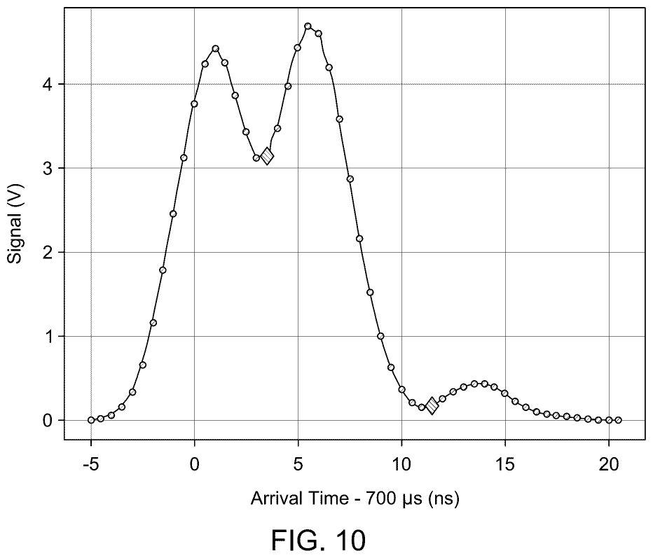

FIG. 10 shows a graphical simulation of spectral feature with a bifurcated peak under heavy space-charge next to a less intense peak belonging to another ion species. This simulated peak may be above the upper or higher threshold (however it is determined). This illustrates that it is possible to have peaks from different ions attached to a bifurcated pulse with high intensity as shown in FIG. 10. To find such peaks in a pulse with high intensity (i.e., that otherwise meets the criteria for not carrying out the first or deconvolution algorithm), a local minimum may be determined (indicated in this figure by diamond markers), where a split would happen if the first algorithm were to be applied. Splitting may be allowed for local minima below a threshold depending on the time-of-flight. This threshold could also depend on the highest intensity in the feature. Therefore, the third algorithm could be adapted to include such a test.

For example, the minimum at the split point is unlikely to be more than around 25% below the maximum in the case of space charge induced bifurcation, but most of the desired splitting comes at a lower level than that. Therefore, the split may only be applied if the ratio of the local minimum to the maximum height falls below a certain level, for example 0.5 or 0.25. A further method may be to always skip splitting in the largest local minimum and only split in lower local minima if their height compared to the highest sample or the largest local minimum falls below a (further) threshold. Similar operations could be performed based on areas of the post-split peaks, or ion numbers, as previously described.

The method and system may be implemented in hardware, software, or a combination of hardware and software. The method and system may be implemented either as a server comprising a single computer system or as a distributed network of servers connected across a network. Any kind of computer system or other electronic apparatus may be adapted to carry out the described methods.

As used throughout, including in the claims, unless the context indicates otherwise, singular forms of the terms herein are to be construed as including the plural form and vice versa. For instance, unless the context indicates otherwise, a singular reference herein including in the claims, such as “a” or “an” (such as an ion multipole device) means “one or more” (for instance, one or more ion multipole device). Throughout the description and claims of this disclosure, the words “comprise”, “including”, “having” and “contain” and variations of the words, for example “comprising” and “comprises” or similar, mean “including but not limited to”, and are not intended to (and do not) exclude other components. Also, the use of “or” is inclusive, such that the phrase “A or B” is true when “A” is true, “B is true”, or both “A” and “B” are true.

The use of any and all examples, or exemplary language (“for instance”, “such as”, “for example” and like language) provided herein, is intended merely to better illustrate the disclosure and does not indicate a limitation on the scope of the disclosure unless otherwise claimed. No language in the specification should be construed as indicating any non-claimed element as essential to the practice of the disclosure.

The terms “first” and “second” may be reversed without changing the scope of the disclosure. That is, an element termed a “first” element may instead be termed a “second” element and an element termed a “second” element may instead be considered a “first” element.

Any steps described in this specification may be performed in any order or simultaneously unless stated or the context requires otherwise. Moreover, where a step is described as being performed after a step, this does not preclude intervening steps being performed.

is also to be understood that, for any given component or embodiment described throughout, any of the possible candidates or alternatives listed for that component may generally be used individually or in combination with one another, unless implicitly or explicitly understood or stated otherwise. It will be understood that any list of such candidates or alternatives is merely illustrative, not limiting, unless implicitly or explicitly understood or stated otherwise.

Unless otherwise described, all technical and scientific terms used throughout have a meaning as is commonly understood by one of ordinary skill in the art to which the various embodiments described herein belongs.

As will be appreciated by the skilled person, details of the above embodiment may be varied without departing from the scope of the present invention, as defined by the appended claims.

For example, whilst the above methods and system have been described with reference to a ToF mass analyser, the technique may be used with other mass analysers.

Many combinations, modifications, or alterations to the features of the above embodiments will be readily apparent to the skilled person and are intended to form part of the invention. Any of the features described specifically relating to one embodiment or example may be used in any other embodiment by making the appropriate changes.

What is claimed is:

1. A method of analysing data generated by an ion analyser, the method comprising:
receiving data generated by the ion analyser;
identifying a region within the data generated by the ion analyser containing at least one feature; and
processing the identified region by:
when one or more properties of the identified region meets one or more criteria using a first algorithm to identify one or more individual peaks within the identified region and a second algorithm to determine properties of the one or more individual peaks within the identified region; and
when the identified region does not meet the one or more criteria using a third algorithm to determine properties of one or more individual peaks within the identified region,
wherein the one or more criteria comprises the maximum intensity value or area of the data within the identified region being below a first threshold.

2. The method of claim 1, wherein the second and third algorithms are the same.

3. The method of claim 1, wherein the second and/or third algorithms are centroiding algorithms to calculate a centre value of the one or more individual peaks.

4. The method of claim 3, wherein the centroiding algorithm provides an output comprising m/z positions or arrival time and intensities of the one or more individual peaks.

5. The method of claim 4, wherein the centroiding algorithm provides an output further comprising a resolution of the one or more individual peaks.

6. The method of claim 1, wherein the first threshold corresponds to an intensity level at which space charge induced bifurcation occurs.

7. The method of claim 1, wherein the one or more criteria comprises the maximum intensity value of the data within the region being above a second threshold.

8. The method of claim 1, wherein the intensity value is any one of: number of counts, number of ions, or number of arbitrary units.

9. The method of claim 1, wherein the threshold is set based on a m/z value or arrival time of a peak within the identified region.

10. The method of claim 9, wherein the threshold is based on a calibration curve including the m/z value or arrival time.

11. The method of claim 1, wherein the first algorithm is a deconvolution algorithm.

12. The method of claim 11, wherein the deconvolution algorithm comprises:
(i) receiving a first segment of data generated by the ion analyser, wherein the first segment of data comprises data associated with a first arrival time range;
(ii) applying a filter to the first segment of data so as to produce a filtered version of the first segment of data, wherein a width associated with the filter is configured to depend upon a width of an expected ion arrival time distribution for the ion analyser for arrival times within the first arrival time range; and then
(iii) identifying one or more ion peaks in the filtered version of the first segment of data.

13. The method of claim 1, wherein the third algorithm comprises the steps of:
identifying a local minimum between two higher intensity local maximum regions within the identified region;
when a difference or a percentage difference between the local minimum and at least one of the two local maximum regions is above a threshold identify the two local maximum regions as separate ion peaks; and
determining the centre positions and/or widths of the two local maximum regions.

14. The method of claim 1, wherein the third algorithm comprises the steps of:
identify a local minimum between two higher intensity local maximum regions within the identified region;
when an intensity of the local minimum is below a threshold identify the two local maximum regions as separate ion peaks; and
determining the centre positions and/or widths of the two local maximum regions.

15. The method of claim 1, wherein the steps of processing the identified region are repeated on a plurality of identified regions until all regions within the data generated by the ion analyser are processed.

16. The method of claim 1, wherein the ion analyser is a time of flight (ToF) mass analyser.

17. The method of claim 16, wherein the step of identifying the region further comprises limiting the width of the identified region to a first arrival time range.

18. The method of claim 1, wherein the step of identifying the region within the data generated by the ion analyser containing at least one feature further comprises the step of:
selecting the region within the data fully enclosing the feature without including a neighbouring feature.

19. An apparatus comprising:
a processor; and
memory storing computer-executable instructions that, when executed by the processor, cause the apparatus to execute the method of claim 1.

20. The apparatus of claim 19, wherein the apparatus is a mass spectrometer.
